(19) United States
(12) Patent Application Publication
(10) Pub. No.: US 2004/0182443 A1
(43) Pub. Date: Sep. 23, 2004

(54) Dual purpose valve

(76) Inventor: Douglas Mclntosh, Ottawa (CA)

Correspondence Address: Francis C. Hand, Esq., c/o Carella, Byrne, Bain, Gilfillan, Cecchi,, Stewart & Olstein, 6 Becker Farm Road, Roseland, NJ, 07068, US

(21) Appl. No.: 10/393,790

(22) Filed: Mar. 21, 2003

(51) Int. Cl. F16K 31/36

(52) U.S. Cl. 137/487

(57) ABSTRACT

A valve for controlling temperature and for water balancing in a zone in a water based heating/cooling system. The valve comprises a housing having a water inlet port and a water outlet port. An internal wall with an opening is positioned between the ports so that when the opening is closed, water flow through the housing from the inlet port to the outlet port is prevented. A plug having predetermined flow rate characteristics is releasably secured in a receptacle in the housing. The plug is constructed and positioned to move with respect to the opening, between open and closed positions, respectively permitting and preventing the flow of water through the housing. A pressure tap is positioned in the housing on the inlet port side of the wall and another pressure tap is positioned in the housing on the outlet side of the wall. The taps, during operation of the valve, permit a determination of the pressure differential between the inlet port and outlet port when the valve is in open position. In this manner, a plug may be selected for insertion for the receptacle with appropriate flow rate characteristics, while maintaining proper water balance, for water delivery to the zone.

### FIELD OF THE INVENTION

This present invention relates to a dual purpose valve. More particularly, this invention relates to a dual purpose valve and method for controlling the temperature and for water balancing in a zone in a water based heating/cooling system.

### BACKGROUND OF THE INVENTION

As heating systems and air conditioning systems have become more complex in their design and operation, water distribution in buildings has become more complex. Since water takes the path of least resistance in short loops, leaving stagnant ends of long loops short of supply, water balancing restrictor valves have been used to balance the system so that all loops can be equal with respect to each other.

The balancing valves used to accomplish this end conventionally contain a fixed restriction or orifice (which can be measured with a differential pressure measuring device) in series with a manually adjusted close-off valve for flow adjustment. These are not flow regulating devices. They are simply manually set restrictor valves adjusted for a given flow and they remain there for the life of the building. Accordingly, when the differential pressure (generated by the circulating pump) changes, the flow changes, and these valves are therefore referred to as “pressure dependent” valves. In other words, they work accurately depending upon the differential pressure (ΔP) remaining the same.

The weak point with such valves is that as loads change from one area or zone to another in a given building, flow (thus ΔP) changes across the balancing valve, since, in order to remain accurate, these valves are dependent upon the differential pressure remaining stable. It often is not stable.

More recently, more exotic water balancing valves have been developed which automatically compensate for ΔP. These valves are set to deliver a given flow, but if the ΔP changes in one section of the building (i.e., the heating load moves around a building as the sun direction changes through the day), then that change in water flow causes a shift in ΔP in one side of the building which is automatically compensated for by the pressure independent water balancing valve. These valves always deliver the same flow, independent or regardless of changes in ΔP in the line. They are therefore referred to as “pressure-independent” balancing valves.

The disadvantage of such valves is that they contain moving parts which are likely to fail before the building life expectancy. Also, they are prone to dirt or grit in the line. They probably constitute only 5-10% of market share compared to pressure-dependent valves due to cost and life expectancy.

For water balance and temperature control in a building, balancing valves are conventionally installed in series with a load and a control valve. While it is usual that the control valve be installed in the supply to the load, and the balancing valve be installed in the return from the load, there is no engineering reason that they be so, unless each is being used as a close-off valve serving the heat exchanger (load). However, in most installations, shutoff valves are installed as separate devices.

Balancing valves disrupt the ability of modulating control valves to perform properly because the control valve cannot operate over its full range if the balancing valve is closed more than the open position of the control valve. Optimally, that would indicate incorrect sizing of the control valve, but the control valve is selected given the design parameters, not the as-built parameters, and all systems are over designed.

To address this problem, conventionally a fixed restrictor balancing valve is added to reduce the flow. In doing that, the control valve is rendered incapable of controlling properly.

Thus, it is an object of the present invention to provide a dual purpose valve, and a method, for controlling temperature and for water balancing in a water based heating system which avoids many of the problems exhibited by these contemporary valve arrangements.

It is another object of the invention to provide a valve that has a valve plug that can be readily replaced by a customized valve plug.

### SUMMARY OF THE INVENTION

In accordance with the present invention there is provided a valve for controlling temperature and for water balancing in a zone in a water based heating/cooling system.

The valve comprises a housing having a water inlet port and a water outlet port. An internal wall with an opening is positioned between the ports so that when the opening is closed, water flow through the housing from the inlet port to the outlet port is prevented. A plug having predetermined flow rate characteristics is releasably secured in a receptacle in the housing. The plug is constructed and positioned to move with respect to the opening, between open and closed positions, respectively permitting and preventing the flow of water through the housing.

A pressure tap is positioned in the housing on the inlet port side of the wall and another pressure tap is positioned in the housing on the outlet side of the wall. The taps permit a determination of the pressure differential between the inlet port and outlet port and thus fluid flow by calculation.

In this manner, a plug may be selected for insertion in the receptacle with appropriate flow rate characteristics, while maintaining proper water balance, for water delivery to the zone.

In addition, the present invention relates to a method for controlling the temperature and for water balancing in a zone in a water based heat transfer system. The method comprises the steps of determining the pressure differential across a plug in a control valve having known flow rate characteristics at a point in a water line supplying the zone. A replaceable cartridge having flow rate characteristics appropriate for the desired water balance in the zone is selected for that point.

The valves and method of the present invention are particularly useful in commercial applications. The valves of the present invention have highly accurately calibrated internals which are designed to give extremely fine control of flow and which are interchangeable. The concept behind the present invention is that if a valve has been purchased which is too large, the size can be changed for the cost of changing the internals (including the plug itself), rather than the need for a balancing valve or the complete replacement and refitting of the entire control valve as is currently done. Valves currently are more capable than ever of controlling flow accurately. With the addition of measuring taps, so that ΔP can be ascertained, the valves and method according to the present invention are able to provide lowered ΔP water balancing as will be described in more detail herein subsequently.

### BRIEF DESCRIPTION OF THE DRAWINGS

These and other advantages of the invention will become apparent upon reading the following detailed description and upon referring to the drawings in which:—

FIG. 1 is a schematic section view, in partial section, of the components of a control valve according to the present invention;

FIG. 1A is an exploded section view of the plug assembly of the control valve of FIG. 1;

FIG. 2 is a section view of the housing of the valve of FIG. 1 along a center line of the housing as viewed from the side; and

FIG. 3 is a section view of the housing of the valve of FIG. 1 along a center line of the housing as viewed from the end.

While the invention will be described in conjunction with an illustrated embodiment, it will be understood that it is not intended to limit the invention to such an embodiment. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

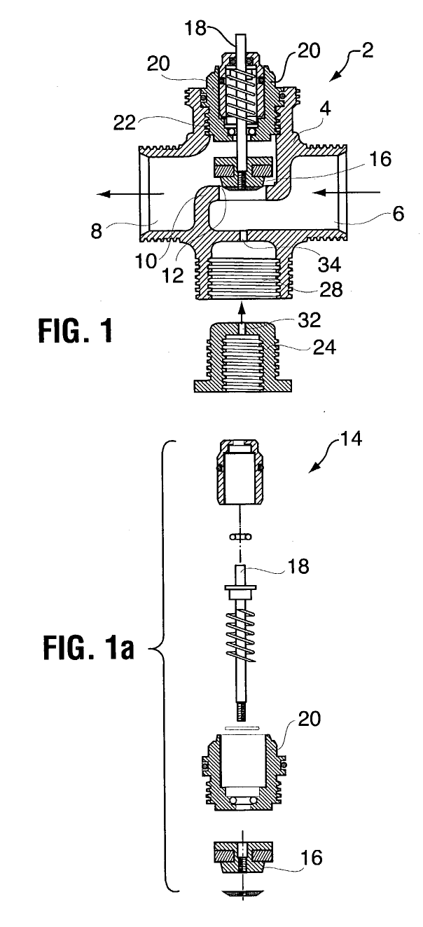

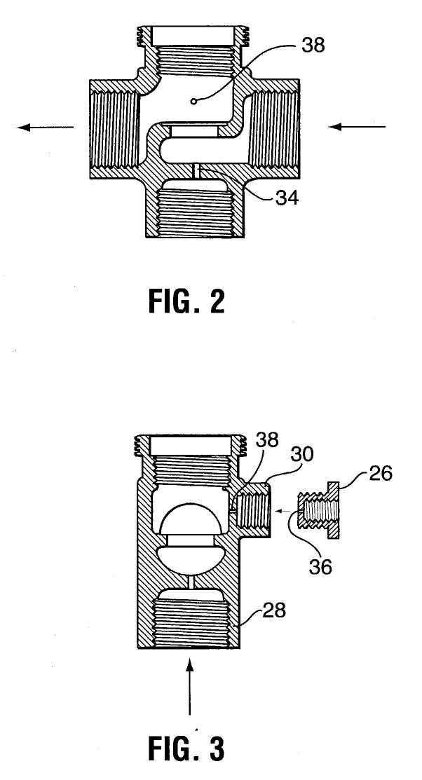

Turning to FIG. 1, there is illustrated schematically a control valve (2), for controlling temperature (and also, if desired, humidity) and for water balancing in a water based heating/cooling system in accordance with the present invention. The valve (2) comprises a housing (4) having a water inlet port (6) and a water outlet port (8). An internal wall (10) is positioned between the ports and has an opening (12) so that when opening (12) is closed, water flow through the housing from the inlet port to the outlet port is prevented.

A plug assembly (14), shown in exploded section view in FIG. 1A, in the form of a cartidge is removably mounted as a unit in the valve housing (4) and is secured in place in a conventional manner. This plug assembly (14) includes a plug (16) mounted at the bottom of a stem (18) for up and down movement in a gland body (20). The gland body (20) is releasably threadable into a receptacle (22) in the housing (4) from the outside of the housing (4).

As illustrated, the stem (18) carries a collar near the upper end, as viewed, that is abutted against a cup-shaped cap secured within the gland (20). In addition, the upper end of the stem (18) passes through the cap to allow the stem (18) to be moved vertically as viewed by a suitable drive (not shown).

A coil spring is positioned around the stem (18) and abuts the gland (20) at one end and abuts the collar fixed to the stem (18) at the opposite end. This spring serves to bias the stem (18) and valve plug (16) upwardly away from the internal wall (10). Alternatively, in a large valve there would be no return spring. Instead, an actuator would be used to either push down or pull up the stem (18).

The plug assembly (14) is constructed and positioned so that the plug (16) moves with respect to the opening (12) between a fully open position and a closed position permitting and preventing the flow of water through housing (4). Plug (16) has predetermined flow rate characteristics, and may be readily replaced with another plug assembly (14) having a plug (16) offering differing flow rates, as may be required, as will be more specifically described hereinafter.

The plug assembly (14) is moved between the open and closed positions by conventional means, such as a motor driven (pneumatic, electric, servo, etc.) actuator which opens and closes or modulates the degree of opening as required.

In the fully open position, the same plug (16) also acts as an orifice of known value for a ΔP measurement and thus, by calculation, flow is determined.

A pressure tap (24) is positioned in the housing (4) on the inlet port side of wall (10) and a similarly constructed pressure tap (26) is positioned in the housing (4) on the outlet side of the wall. These taps are in the nature of self-sealing plugs which are securably and threadably received in sockets (28) and (30) respectively, in the sides of the housing (4) as illustrated. Pressure tap (24) has a self-sealing aperture (32) which is aligned with a small aperture (34) in the outer wall of housing (4); pressure tap (26) similarly has a self-sealing aperture (36) which is aligned with aperture (38) in the outer wall of housing (4) (see FIG. 3). These apertures receive a conventional pressure measurement sensor (not illustrated) which has a needle-like portion which is injectable through these aligned apertures in each case, into the interior of housing (4) on the appropriate side of wall (10), in order to give an accurate reading of the water pressure in that part of the housing. In this way, the differential pressure ΔP across the valve may be measured.

When in the wide open position, the plug assembly (14) has a precise flow rate (Cv) at a ΔP of 1 psi. Each valve is marked on the top of the plug assembly as to its exact Cv (USGPM at 1 psi ΔP). Tests have proved that repeatability of this flow rate is excellent.

Thus, if that factor is used, i.e. the Cv stamped on the plug assembly or plug assembly cartridge, in combination with ΔP information obtained from the pressure taps (24) and (26), the equivalent of a standard balancing valve plus a control valve is provided in a single valve.

The valve (2) in accordance with the present invention differs from conventional control valves in that it uses accurately calibrated replaceable internals (plug assembly (14)) with a known water delivery Cv (flow rate) at 1 psi ΔP. The selection of a pre-calibrated cartridge, when combined with the ΔP readings from pressure taps (24) and (26), can now be used for water balancing as well, i.e., a cartridge is provided having two functions: as a modulating insert for the valve (2) and also as a measured and calibrated orifice in its wide open position for measuring flow.

The ΔP of the valve (2) can be measured using the pressure taps (24) and (26), for a variety of plug assemblies (14) having a range of Cv's, and these ΔP's can be cross-referenced with the Cv's to provide a cross-reference chart.

In operation, the valve 2 is to be driven wide open (either manually or electrically from a building automation system, or a thermostat, or otherwise), and the ΔP taps (24) and (26) are plugged into a ΔP meter (not illustrated). The meter reading is read and the flow is computed by a cross-reference chart or by calculation (flow in USGPM=[P2/P1]\hat{ }2×Cv measured), where the Cv is supplied and indicated on the top of the factory calibrated plug assembly cartridge (14).

If the flow is too high or too low to meet the requirements of the controlled heat exchanger, then the replaceable plug assembly cartridge (14) will have to be changed for the correct size for the existing ΔP measured, the correct size to be selected from the flow charts or the formula:

Cv required=Cv measured×{[P2/P1]\hat{ }2}

The valve (2) according to the present invention differs from conventional control valves in that it includes the taps (24) and (26) for use with ΔP measuring gauges so that actual ΔP is known and thus flow can be determined by calculation or from such a cross-reference chart. It also differs from current balancing valves in that it uses only one accurately factory calibrated internal element (plug assembly (14)) when providing the ΔP reading, thus permitting the flow to be read by calculation or by cross-reference chart. Moreover, The valve (2), in the balancing context, differs from current balancing valves in that it does not require a flow adjusting dial with elaborate tamper resistant settings nor a rotating dial. Instead it is fitted with a pre-calibrated and stamped and certified dual purpose internal cartridge (plug assembly (14)) which is readily replaceable by a technician where a different Cv is required but cannot be tampered with by unauthorized personnel.

The valve and method of controlling the temperature and balancing in a heating system according to the present invention provide many significant advantages including economy (since a single valve takes the place of two) and effectiveness (since one valve per location as opposed to two will reduce system pressure drop). This will reduce the relative cost since a smaller pump or trimmed impellor pump can be used. A smaller pump will use less electricity and will incur less maintenance and delay ultimate replacement. As well, with only a single valve, control is improved since the control valve (2) will operate through its full span when controlling.

The invention thus provides a valve that has a housing that can be permanently installed in a water line and a plurality of plug assemblies for selective mounting in the housing. Each plug assembly includes a plug for movement between a closed position seated in the opening of the internal wall to block a flow of water from the inlet port to the outlet port and a fully open position spaced from the opening in the internal wall to allow a flow of water from the inlet port to the outlet port. In addition, each plug of each of the plug assemblies has a predetermined calibrated capacity value (Cv) different from the other of the plugs whereby with a plug in the fully open position and for a pressure drop (Δp) of one psi across the opening of the internal wall, said predetermined calibrated capacity value (Cv) of the plug defines the amount of 60° F. water flow per minute through the housing.

Alternatively, the valve may be constructed as a three-way valve or with a third port for bypass or mixing applications where the maximum flow is similarly restricted to meet water balancing needs as well as control needs.

The dual purpose valve is suitable for heating or cooling as well as for water or steam, gylcol or oils (as used in the far North) or any other fluid.

Additionally, an actuator (pump, electric, thermometer, and the like) is connected so as to drive the plug from maximum Cv required for proper water balancing to reduced or closed position to suit the requirements of that controller's humidista- or themostat-or controller or computer, and the like.

Thus, it is apparent that there have been provided in accordance with the invention a valve and method for controlling the temperature and for water balancing that fully satisfy the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What is claimed is:

1. A valve for controlling temperature and for water balancing in a zone in a water based heating/cooling system, the control valve comprising a housing having a water inlet port and a water outlet port, an internal wall with an opening positioned between the ports so that when the opening is closed, water flow through the housing from the inlet port to the outlet port is prevented, a plug, releasably secured in a receptacle in the housing, the plug constructed and positioned to move with respect to the opening between open and closed positions, respectively permitting and preventing the flow of water through the housing, the plug having predetermined flow rate characteristics, a pressure tap positioned in the housing on the inlet port side of the wall and a pressure tap positioned in the housing on the outlet side of the wall, the taps during operation of the valve permitting a determination of the pressure differential between the inlet port and outlet port when the valve is in open position, whereby a plug may be selected for insertion in the receptacle with appropriate flow rate (Cv) to maintain proper water balance, for water delivery to the zone.

2. A method for controlling the temperature and for water balancing in a zone in a water based heat transfer system, the method comprising the steps of determining the pressure differential across a plug in a control valve having known flow rate characteristics at a point in a water line supplying the zone, and selecting a control valve for that point which valve has flow rate characteristics appropriate for the desired water balance in the zone.

3. A method according to claim 2, wherein the flow rate in the zone for a variety of differential pressures across the point is cross-referenced so that a control valve having an appropriate flow rate characteristics for the desired water balance in the zone may be accordingly selected.

4. A method for controlling the temperature and for water balancing in a zone in a water based heat transfer system, the method comprising the utilization of the same cartridge for system balancing but after the selecting of the characteristic parabolic disc assembly aattached to the plug.

5. A valve comprising
a housing having a water inlet port, a water outlet port and an internal wall positioned between said ports, said wall having an opening for passage of water from said inlet port to said outlet port;
a dual purpose plug assembly removably mounted in said housing, said assembly including a plug movably mounted between a closed position seated in said opening of said wall to block a flow of water from said inlet port to said outlet port and a fully open position spaced from said opening in said wall to allow a flow of water from said inlet port to said outlet port, said plug having a predetermined calibrated capacity value (Cv);
a first pressure tap mounted on said housing in communication with said inlet port to mount a first pressure measurement sensor therein for measuring the pressure of water in said inlet port; and
a second pressure tap mounted on said housing in communication with said outlet port to mount a second pressure measurement sensor therein for measuring the pressure of water in said outlet port whereby with said plug in said fully open position and for a pressure drop (Δp) of one psi across said opening of said wall, said predetermined calibrated capacity value (Cv) of said plug defines the amount of 60° F. water flow per minute through said housing.

6. A valve as set forth in claim 5 wherein said plug assembly includes a stem having said plug mounted at one end thereof and a spring biasing said stem to move said plug into said opened position, said stem extending out of said housing at an opposite end from said plug.

7. A valve as set forth in claim 5 wherein said plug assembly includes a stem having said plug mounted at one end thereof and extending out of said housing at an opposite end from said plug for securement to an actuator.

8. In combination,
a housing having a water inlet port, a water outlet port and an internal wall positioned between said ports, said wall having an opening for passage of water from said inlet port to said outlet port;
a first pressure tap mounted on said housing in communication with said inlet port to mount a first pressure measurement sensor therein for measuring the pressure of water in said inlet port;
a second pressure tap mounted on said housing in communication with said outlet port to mount a second pressure measurement sensor therein for measuring the pressure of water in said outlet port; and
a plurality of plug assemblies for selective mounting in said housing, each said plug assembly including a plug for movement between a closed position seated in said opening of said internal wall to block a flow of water from said inlet port to said outlet port and a fully open position spaced from said opening in said wall to allow a flow of water from said inlet port to said outlet port, said plug of each of said plug assemblies having a predetermined calibrated capacity value (Cv) different from the other of said plugs whereby with said plug in said fully open position and for a pressure drop (Δp) of one psi across said opening of said wall, said predetermined calibrated capacity value (Cv) of said plug defines the amount of 60° F. water flow per minute through said housing.

9. A valve as set forth in claim 8 wherein each of said plug assemblies is threaded for removable mounting in said housing.

10. A valve as set forth in claim 8 wherein each of said plug assemblies includes a stem having said plug mounted at one end thereof and a spring biasing said stem to move said plug into said opened position, said stem extending out of said housing at an opposite end from said plug.
